(19) United States
(12) Patent Application Publication
(10) Pub. No.: US 2007/0234644 A1
(43) Pub. Date: Oct. 11, 2007

(54) Sliding window assembly

(76) Inventors: Jurgen Jaeger, Winnipeg (CA); Scot Fjeldsted, Stony Mountain (CA); Ivan Harder, Winnipeg (CA); Drew Ramsdale, Winnipeg (CA)

Correspondence Address: Gowling Lafleur Henderson LLP;Suite 1600, 1 First Canadian Place, 100 King Street West, Toronto, ON, M5X 1G5, CA

(21) Appl. No.: 11/730,344

(22) Filed: Mar. 30, 2007

Related U.S. Application Data
(60) Provisional application No. 60/787,535, filed on Mar. 31, 2006.

(51) Int. Cl. E05D 15/10

(52) U.S. Cl. 49/362; 49/209; 49/213

(57) ABSTRACT

The present invention provides a sliding window assembly having a fixed window portion and a sliding window portion. The sliding window portion is operable to move in a perpendicular direction relative to the fixed window portion and also is operable to move parallel to the fixed window portion to slide behind the fixed window.

### FIELD OF THE INVENTION

The present invention relates to an in-line window for use in a vehicle and more particularly relates to an in-line power slider window.

### BACKGROUND OF THE INVENTION

Sliding windows are often used in transport vehicles, e.g. buses and streetcars. Such windows are generally small in size and comprise two adjacent panes of glass, one of which is fixed in place and one of which is operable to slide in front of or behind the other. In order to open the window an opening mechanism, e.g. latch, is provided located adjacent the moveable glass.

Sliding windows located on transportation vehicles must be able to withstand excessive continual use. Such windows should be easy to operate and preferably reduce noise influx from outside the vehicle.

### SUMMARY OF THE INVENTION

In one embodiment the present invention provides a window assembly comprising at least one fixed window pane, at least one drive shaft extending parallel to the longitudinal axis of the fixed window pane and at least one sliding window pane mounted on the at least one drive shaft and operable to slide therealong, the sliding window pane also being operable to be displaced in a perpendicular direction relative to the fixed window pane.

In an alternative embodiment the present invention provides a sliding window assembly comprising a frame, at least one fixed window portion mounted within the frame and an upper and a lower drive shaft each comprising a pair of sliding members mounted upon the drive shafts, each of the sliding members are operable to move along the corresponding drive shaft to which they are attached. The window also includes at least one displaceable window portion comprising a plurality of projections extending from the window. Each of the projections are operable to be received within one of the sliding members to connect the window to the sliding members. The displaceable window portion is operable to move perpendicular to the drive shafts and also parallel thereto.

In a further embodiment the present invention provides a power sliding window assembly comprising a frame with at least one fixed window portion mounted within the frame, an upper and a lower drive shaft each comprising a pair of sliding members mounted thereon, each of the sliding members operable to move along the corresponding drive shaft. The window assembly also includes at least one displaceable window portion positionable between a plurality of open configurations and a closed configuration and connected to each of the sliding members for sliding the displaceable window portion between the open and closed configurations. The displaceable window is operable to move perpendicular and parallel relative to the drive shafts when opening and closing and a motor assembly, that is operably connected to at least one of the upper and lower drive shafts, drives the at least one drive shaft to allow the corresponding sliding members tom move along the at least one drive shaft.

In a further embodiment the present invention provides a sliding window assembly that includes at least one guide means coupled to the frame that guides the displaceable window in a perpendicular direction and/or a parallel direction relative to the drive shaft.

In a further embodiment the present invention provides a sliding window assembly that includes a screen mounted on the interior portion of the window and extending along the fuill length of the window.

### BRIEF DESCRIPTION OF THE DRAWINGS

The present invention will be discussed in further detail below with reference to the accompanying drawings in which:

FIG. 1 is a side view of one embodiment of the slider window of the present invention;

FIG. 2 is a side view of the slider window of FIG. 1 showing the displaceable pane in an open position;

FIG. 3 is an isometric interior view of the slider window of FIG. 1 without the mainframe;

FIG. 4 is an interior side view of the slider window of FIG. 1;

FIGS. 5 A through E are cross section views showing the operation of the slider window of FIG. 2 taken along lines 5-5;

FIG. 6 is a side cross sectional view of the fixed glass and drive belt of the slider window of FIG. 1 taken along line 6-6;

FIG. 7 is a side cross sectional view of the sash glass of the slider window of FIG. 1 taken along line 7-7;

FIG. 8 is a side cross sectional view of the fixed glass and the sash glass of FIG. 2 taken along line 3-3;

FIG. 9 is a top cross sectional view of the slider window of FIG. 1 taken along line 4-4;

FIG. 10 is a top cross sectional view of the slider window of FIG. 2 taken along line 10-10;

FIG. 11 is an exploded view of the slider window of FIG. 1; and

FIG. 12 is an exploded view of an alternative embodiment of the sliding window assembly of the present invention.

### DETAILED DESCRIPTION OF THE PREFERRED EMBODIMENTS

The present invention provides a sliding window assembly having a fixed window portion and a sliding window portion. The sliding window portion is operable to move in a perpendicular direction relative to the fixed window portion and also is operable to move parallel to the fixed window portion to slide behind the fixed window. The power slider window also includes a motor assembly coupled to the sliding window for moving the sliding window relative to the fixed window. When closed the fixed window portion and the sliding window portion lie adjacent each other within the same plane. Upon opening of the window, using the motor, the sliding window moves perpendicular to the fixed window and inwardly thereof. Once the sliding window has moved inwardly of the fixed window a predetermined distance it is operable to slide parallel to the fixed window to fit behind the fixed window. This configuration provides an opening where the sliding window was initially located. When the window is closed the opposite movement of the sliding window occurs until it rests adjacent the fixed window.

The power slider window includes guide means located adjacent one edge of the sliding window for guiding the window when opening and closing. Perpendicular guides are provided to assist in the opening of the window. The perpendicular guides and parallel guides are provided to assist the closing of the window.

The present invention will now be described in further detail with reference to the accompanying figures in which the power slider window is indicated generally at numeral 10.

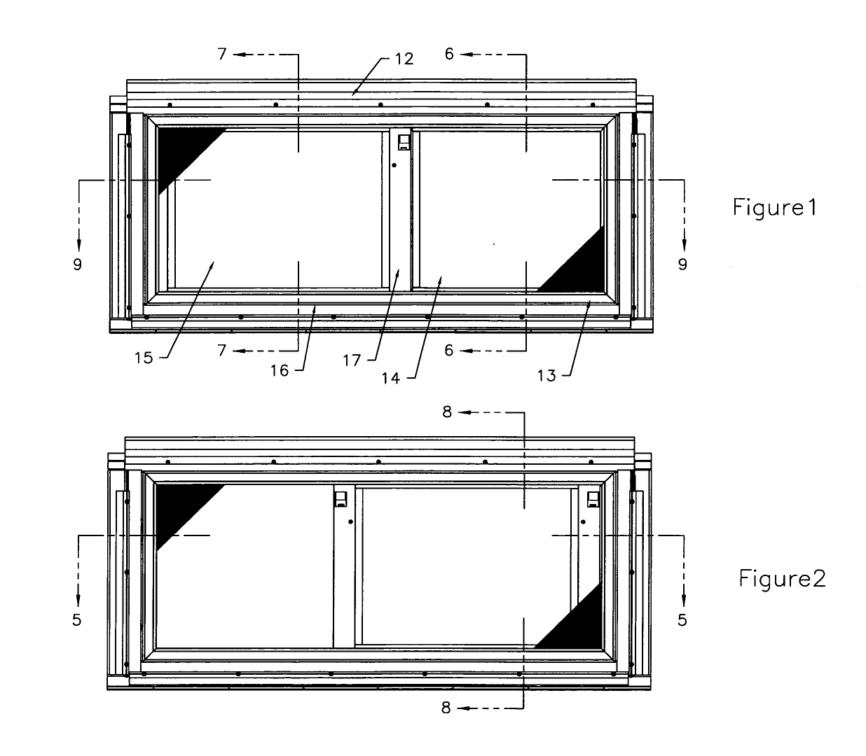

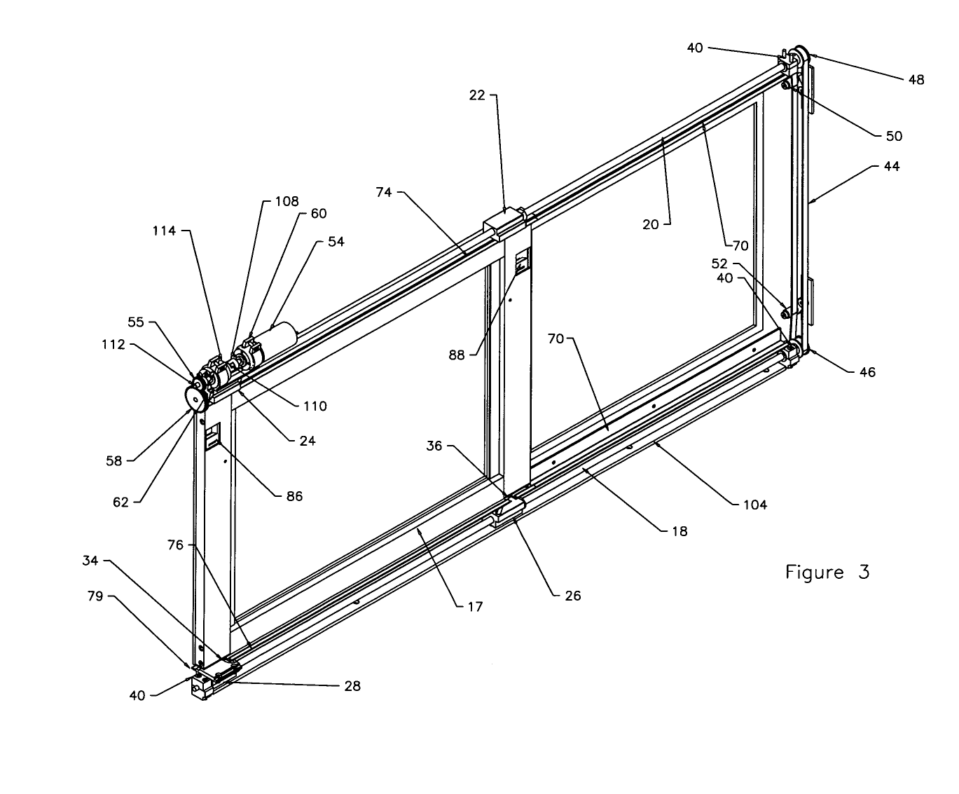

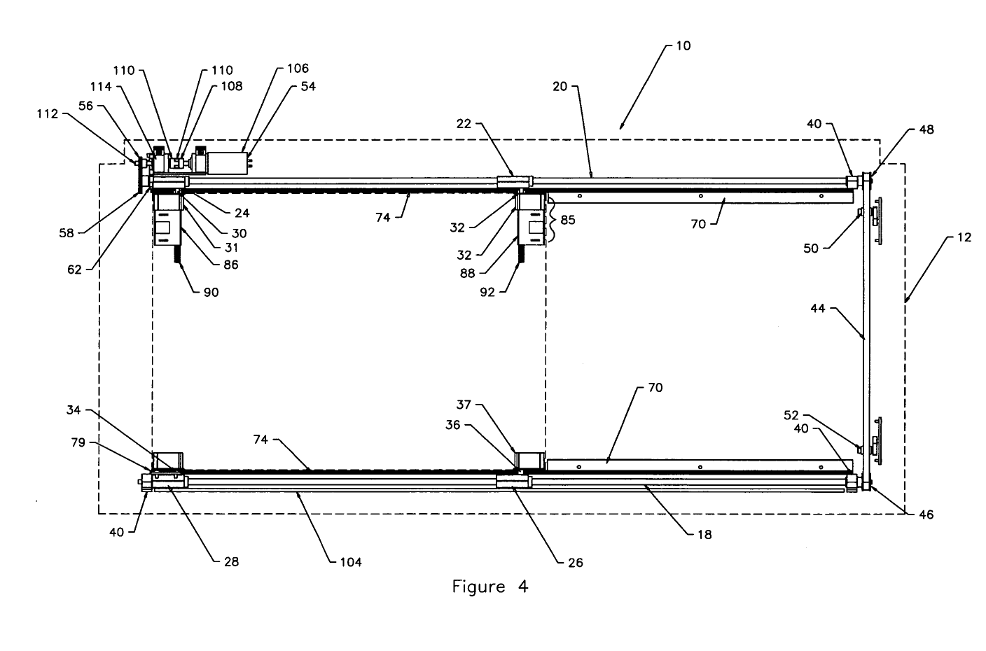

As can be seen in FIG. 1, the window 10 includes a mainframe 12 having a fixed window portion 13 including a window pane 14 and a displaceable window portion 16, also referred to herein as a sliding window, including a window pane 15 fixed within a sash frame 17. When window 10 is closed, fixed window portion 13 and displaceable window portion 16 lie within the same plane, adjacent one another. When the window 10 is fully open, displaceable window portion 16 lies parallel to and behind fixed window portion 13. The positioning of both windows 13, 16 will be discussed in further detail below. It will be understood by a person skilled in the art that any type of glazing material, suitable for the end use, may be used in the window 10. The internal components of the window 10 will be described in more detail and can be seen more clearly in FIGS. 3 and 4.

As can be seen in FIGS. 3 and 4, located above and below fixed window portion 13 and displaceable window portion 16 are parallel threaded drive shafts 18, 20, herein referred to as lower drive shaft 18 and upper drive shaft 20. The drive shafts are provided to allow the displaceable window portion 16 to move, or slide, therealong, in a manner described in further detail below. The drive shafts should be sized to fit within the window assembly and to provide sufficient support for the displaceable window.

Mounted on the lower and upper drive shafts 18, 20, in the vicinity of displaceable window portion 16, are four sliding members including two upper sliding members 22, 24 mounted on the upper drive shaft 20 and two lower sliding members 26, 28 mounted on the lower drive shaft 18. Examples of suitable sliding members that may be used include, but are not limited to, cam follower blocks that are known in the art. The sliding members and their use are described in further detail below and are operable to be mounted on one of the drive shafts and operable to connect to the displaceable window portion.

Each sliding member includes a thread that matches the thread on the drive shaft in order to enable movement of the sliding member along the drive shaft to which it is mounted. Each sliding member is mounted on the corresponding threaded drive shaft to allow movement of the sliding member forwards and backwards along the entire length of the threaded drive shaft.

The displaceable window portion 16 is connected to the sliding members 22, 24, 26 and 28 by pins 30, 32, 34 and 36. The sliding members 22, 26 are located at the opposite end of the window portion 16 from sliding members 24, 28, i.e. there is a sliding member located at each of the four comers of the window portion 16. The placement of the sliding members at each corner of the window portion 16 provides support for the window portion 16 while closed and during opening and closing as the sliding members support the window as it travels along the drive shafts. The placement of the sliding members is preferably as illustrated in the accompanying Figures, however, it will be understood that variations to these positions may be made provided that the window is still adequately supported when closed, opened and during operation, i.e. opening and closing. Further it will be understood that only three sliding members are required for the window to finction, two at the bottom of the window and one at the top. Preferably the sliding members are made from plastic material in order to minimize friction.

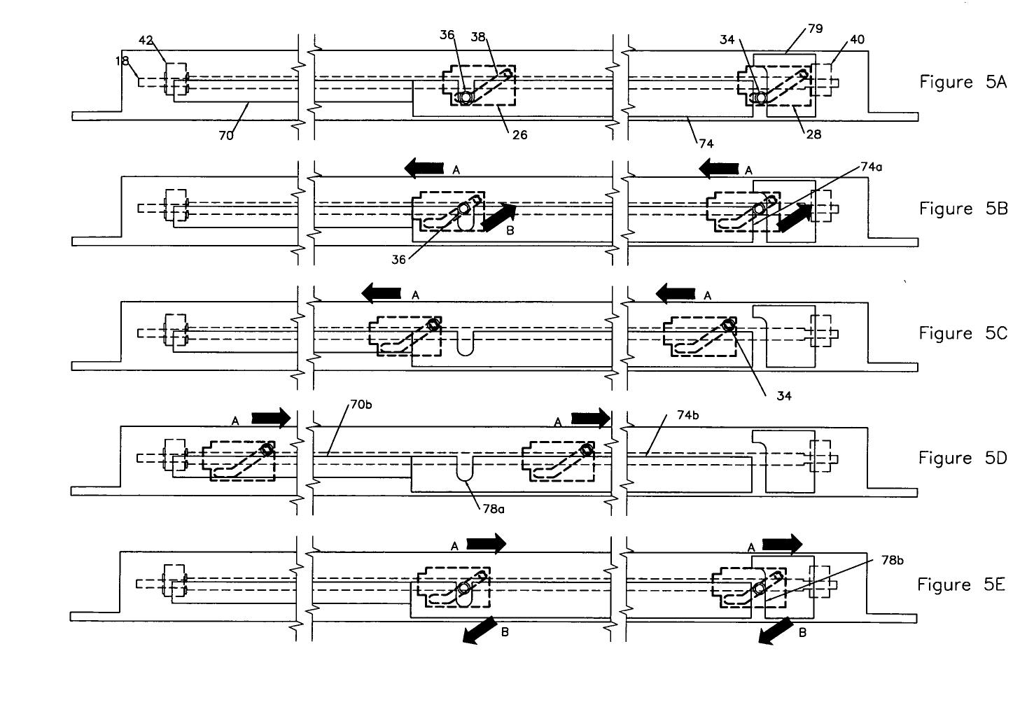

Turning to the displaceable window portion 16, each pin 30, 32, 34 and 36 is located in a corresponding pin housing 31, 33, 35 and 37 which are each connected to the sash frame 17 at a corner, as illustrated in FIG. 4. Each of the upper two pin housings 31,33 form part of a latch assembly 85 described below. Each pin extends from the displaceable window portion 16 at a position adjacent and in a direction towards each corresponding sliding member and further extends into the corresponding sliding member. As an example, pin 36 downwardly extends from displaceable window portion 16 towards and into sliding member 26. Preferably, each pin extends into a channel 38 located in each of the sliding members 22, 24, 26 and 28, as seen clearly in FIGS. 5A through E and described in more detail below.

It should be noted that pins 30, 32 are operable to extend from and withdraw into the top portion of the displaceable window portion 16 to allow for the removal of the displaceable window portion 16 from the slider window 10 if required. The latch assemblies 85 include release latch catches 86,88, that are described below, which control the movement of corresponding pins 30, 32. The removal of the displaceable window portion 16 will also be described below. The pins 30, 32, 34 and 36 are preferably made from metal and are operable to hold the window portion 16 in place and to withstand the continual use of the window opening and closing. Preferably the pins are made of steel.

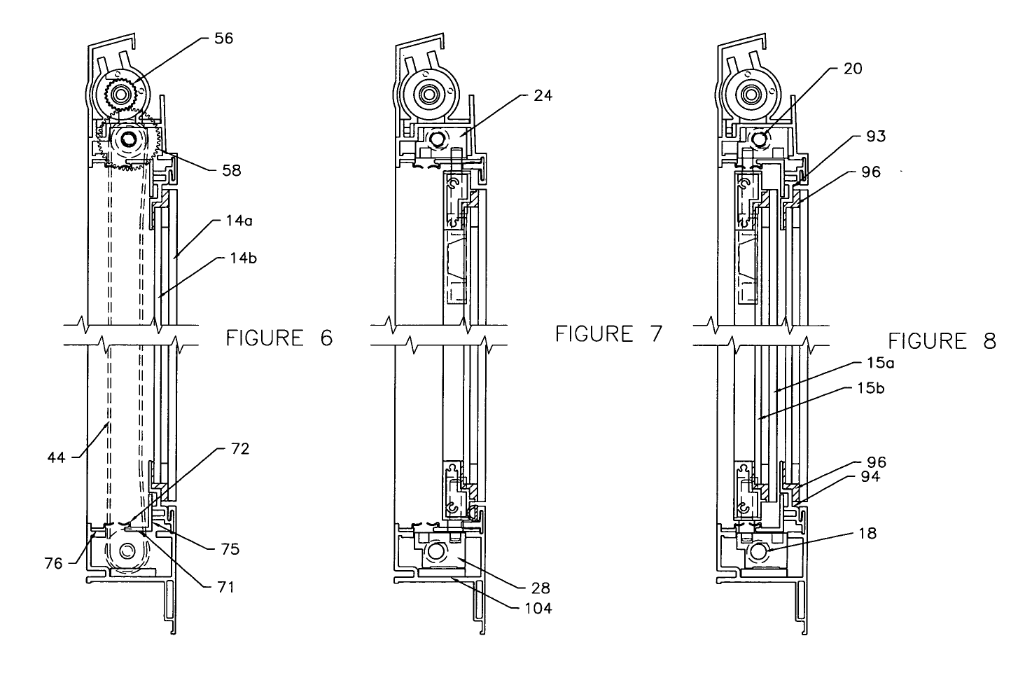

Located at the top and bottom of the fixed window portion 13 are fixed guide covers 70, also referred to as sash guide covers, clearly shown in FIGS. 6 and 9, each including rigid portion 71 which is connected to the fixed window portion 13 and extends away from the bottom of the fixed window portion 13 in an inward direction relative to an installed window. When viewed from above, as shown in FIGS. 5A-E, the guide cover 70 is substantially rectangular in shape. The guide cover also includes flexible portion 72, shown in FIGS. 6-8. The rigid portion 71 of guide cover 70 acts as a guide for the displaceable window portion 16 when it moves along the drive shafts behind fixed window portion 13 when the window is closing. Each guide cover 70 is attached to the mainframe at the rigid portion 71 using fasteners or other suitable attachment means. As can be seen in FIGS. 6-8 in the embodiment illustrated the guide covers 70 include an upwardly extending portion, indicated at numeral 75 that connects to the main frame 12 via fixed glazing adapter 94. The connection of these pieces may be made through any means known to a person skilled in the art, for example, but not limited to, by fasteners or by adhesion, e.g. welding. The guide covers may also be attached directly to the mainframe 12.

As illustrated, the upwardly extending portion 75 is integral with the rigid portion 71 of the guide cover 70. However, these may be two separate pieces that are attached or the rigid portion 71 may be connected to the mainframe in a different manner.

Sliding sash guide covers 74 are connected to the mainframe 12 adjacent the sash frame 17 when in a closed configuration. The sliding sash guide covers 74 are clearly illustrated in FIGS. 5A through E and also include a rigid portion and a flexible portion as described above for guide covers 70. The sliding guide covers 74 are substantially rectangular in shape and include opening 78a, identified in FIG. 5C, at the end located adjacent the fixed window portion 13. The opening 78a is sized to receive one of the pins, for example pin 36. Located opposite the guide covers 70, 74 is elongated guide cover 76, shown in FIGS. 6-10, which extends the full length of the window 10. Elongated guide cover 76 includes a rigid portion that is connected to the mainframe 12 and a flexible portion 77 that is similar to the flexible portion 72 located on guide covers 70, 74. The flexible portions of the guide covers act as covers for the channel along which the pins travel, as can be seen in FIGS. 6-8. The flexible portions are displaced by the pins as they move along the channel during the opening and closing of the window 10. The flexible portions are made of a suitable material that is durable and flexible enough to be moved by the pins. It will be understood from the description of the operation of the window assembly provided below that the guide covers 70, 74, 76 also act as guide means for the pins in their movement within each corresponding sliding member which translates into the movement of the displaceable window. It will therefore be understood that the guide covers 70, 74 and 76 may also be referred to as guide means.

Located at the end of the lower drive shaft 18 is a guide means 79, also referred to herein as an end stop or sash end stop. Guide means 79 is connected to the mainframe 12 using fasteners 81. It will be understood that any suitable connection means may be used to secure the guide means 79 to the frame. The guide means 79 has a first inner edge that includes a cut away portion used to guide pin 34 therealong when the window is opening and closing. The general shape of the cut away portion is substantially L-shaped with the lower portion of the “L” being curved inwardly to change the direction of the pin through 90°, described in further detail below. The cut away portion forms an opening 78b with the end of the guide cover 74 that is sized to receive the pins.

The drive shafts 18, 20 will now be described in more detail. The lower drive shaft 18 includes two shaft support blocks 40 located at opposite ends to hold the drive shaft 18 in place. The upper drive shaft 20 also includes a shaft support block 40 at one end and is held in place at the other end by a motor assembly. Located adjacent the outer end of fixed window portion 13 is a drive belt 44 mounted on two pulleys 46, 48 located at the top and bottom of the window 10 and at one end of the drive shaft 18, 20. The tension of the drive belt 44 is maintained by a pair of drive belt tensioners 50,52 located at either end of the drive belt 44. The drive belt tensioners 50, 52 are connected to corresponding mounting devices 51,53 which are connected to the mainframe 12 using rivets. It will be understood by a person skilled in the art that other ways of connecting the drive belt tensioners 50, 52 to the mainframe 12 may be used.

The upper drive shaft 20 is connected, at the end adjacent the displaceable window portion 16, to a motor 54 through gears 56, 58. The motor 54 drives gear 56 that in turn drives gear 58 that is connected to the upper drive shaft 20. The power provided by the motor 54 is translated to the lower drive shaft 18 through the drive belt 44. The motor 54 is mounted to the mainframe 12 by motor mount 60 and motor mount end plate 62 which also holds the upper drive shaft 20 in place. The motor mount end plate 62 is operable to maintain the motor and the drive shaft in an operating configuration that prevents the gears on the motor and the shaft from disengaging. The motor is connected to a switch, not shown, that is operable to allow a user to turn the motor on or off. The switch may be located adjacent the motor, or may be integral with the motor, or may be located remotely from the motor, for example at a position that is operable by the driver of the vehicle within which the window assembly is mounted. It will be understood that the present invention is not limited to include a motor assembly as described or illustrated herein. Any motor assembly known by a person skilled in the art may be used that provides power to the window to allow for movement of the displaceable window pane along the drive shafts.

As can be seen in FIG. 4, displaceable window portion 16 also includes latch assemblies 85 that each include a release latch 86, 88 located on the upper side of the displaceable window portion 16 adjacent pins 30, 32. The release latches 86,88 are connected to corresponding pins 30,32 and are operable to retract the pins 30,32 from their corresponding sliding members 24,22 to assist in the removal of the displaceable window portion 16 from the power slider window 10. The pins 30, 32 are normally biased to extend into the associated sliding members 24, 22 by latch springs 90,92. Downward movement of the release latches 86, 88 overcome the springs 90,92 which in turn retracts the pins 30, 32.

As seen clearly in FIGS. 6-8, each of the panes 14, 15 are preferably bonded in place. Having the displaceable pane 15 bonded to the sash 16, as opposed to being held in place by pins, provides a simple window design. The bonded design not only makes the window simpler than many traditional designs but also provides improved water tightness and reduced wind noise when installed and in use.

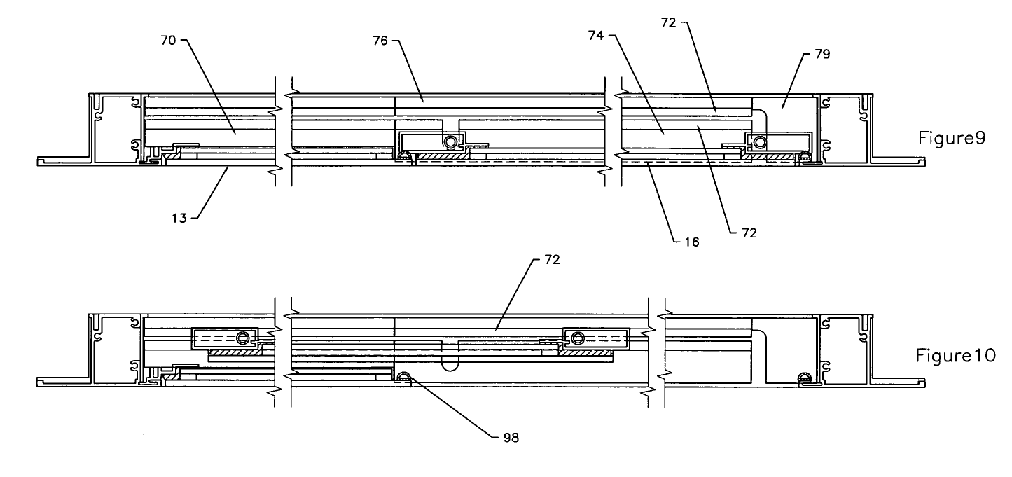

FIGS. 6 through 8 illustrate a series of cross sectional views, taken perpendicular to the length of the window 10. FIG. 6 illustrates a side view taken through the centre of fixed window portion 13. As can be seen the fixed pane 14 is bonded to the mainframe 12. In particular, and as illustrated in the preferred embodiment, the pane 14, which includes two pane portions 14a and 14b. Each pane is bonded to a pair of fixed glazing adapters 93, 94, identified in FIG. 8, located along the upper and lower edges of the pane 14. The fixed pane 14 is bonded along a portion of each pane 14a, 14b to the fixed glazing adapters 93, 94 using structural adhesive 96. The adhesive may be any adhesive known in the art and includes, but is not limited to, structural polyurethane. In addition, a fixed glazing adapter, not shown, is located along the side of the pane 14 located at the edge of the window, i.e. the edge that is not located at the centre of the window between the displaceable and fixed windows.

The outer end of each fixed glazing adapter 93, 94, i.e. the end not adhered to the fixed pane 14, is connected to the mainframe 12. It will be understood by a person skilled in the art that the connection for the fixed glazing adapters 93, 94 to the mainframe 12 may be through any known means. Further, it will be understood that these pieces may be integrally connected before assembly of the window 10 and may therefore comprise one piece. Similarly, pane 15 also includes two pane portions 15a, 15b which are each bonded, as described above, to the sash frame 17.

As can be clearly seen in FIG. 7, the window 10 also includes a compression seal 98 connected to the mainframe. The compression seal 98 provides a seal between the mainframe 12 and the displaceable window portion 16 when closed. The compression seal 98 extends along the length of the displaceable window portion 16. As can be seen, the compression seal 98 of the illustrated embodiment has a cross-sectional “D” shape. However, it will be understood by a person skilled in the art that any shape may be used provided that it creates a seal between the displaceable window portion 16 and the mainframe 12. It will be understood that the compression seal 98 may be made from any material known in the art for maintaining a seal. An example of a suitable type of material to use is EPDM closed cell foam. However, this material is only an example of the type that may be used and is not meant to be limiting.

The operation of the power slider window 10 will now be discussed with reference to the figures identified below. When viewing FIGS. 5A through E, the direction of movement of the sliding members is indicated by Arrow A and the direction of movement of the pins is indicated by Arrow B. FIG. 5A shows the sash frame in a closed position, FIGS. 5B and 5C show the sash frame opening, FIG. 5D shows the sash frame full open and beginning to close and FIG. 5E shows the sash frame closing.

The displaceable window portion 16 starts out flush with outer surface of the fixed glass window 14, as illustrated in FIG. 1 and FIG. 5A and as seen more clearly in FIG. 9. When opened, the sash frame 17 slides in perpendicular to the outside of the window until it is positioned inwardly relative to the fixed window portion 13, at which point the sash frame 17 moves laterally behind the fixed window portion 13. For ease of reference the operation of the window will be described with reference to the lower portion only. It will be understood that the operation of the lower portion of the window will also reflected by the upper portion of the window. The pins 34 and 36 at the comers of the sash 16 are retained by the corresponding sliding members 26 and 28.

When the sliding members 26 and 28 initially begin to move along the drive shafts, powered by the motor assembly, pin 34 is guided between the guide means 79 and the end of sliding sash guide cover 74 while pin 36 moves within opening 78a of the sliding sash guide cover 74. As can be seen in FIG. 5A the sash guide cover end edge 74a, adjacent guide means 79 prevents pin 34 from moving in the direction of the sliding member 28. Instead pin 34 is guided along the end edge 74a of the sash guide cover 74 in a perpendicular direction, relative to the drive shaft, along opening 78b, while travelling along the channel 38 located in sliding member 28. This movement guides the sash frame 17 that is attached to the pins towards the interior of the window and perpendicular to the drive shafts. Simultaneously pin 36 is also guided in the same direction as pin 34 by the inside edge of opening 78a while travelling along the channel 38 of sliding member 26.

When pin 34 reaches the side edge of the sash guide cover 74 and the curved portion of the edge of guide means 79, pin 34 is retained at one end of the channel of sliding member 28. Likewise when pin 36 reaches the end of the opening 78a it is retained at one end of the channel in sliding member 26. At this time the direction of travel of pins 34, 36 is changed to correspond to that of the respective sliding members 26, 28 and they travel along the drive shaft as the sash frame 17 slides open, as seen in FIG. 5C.

When the sash frame 17 is closing, shown in FIG. 5D, the inside edges 70b, 74b of the sash guide covers 70, 74 keep the pins 34,36 retained at the end of the corresponding sliding members 26,28 as the sash slides closed. When pin 34 travels past the sash guide cover 74, shown in FIG. 5E, pin 34 will contact guide means 79 at opening 78b. At this point the pin 34 can no longer travel in the same direction as the sliding member 28. The pin 34 will therefore be forced to move back along channel 38 of the sliding member 28 as the sliding member 28 continues to move in the direction illustrated by arrow A. As the pin 34 travels along the channel 38 of the sliding member 28 it moves towards the outside of the window along sliding sash end edge 74a. At the same time pin 36 will move into opening 78a and the sash frame 17 will therefore move perpendicular to the drive shaft towards the closed position illustrated in FIG. 5E.

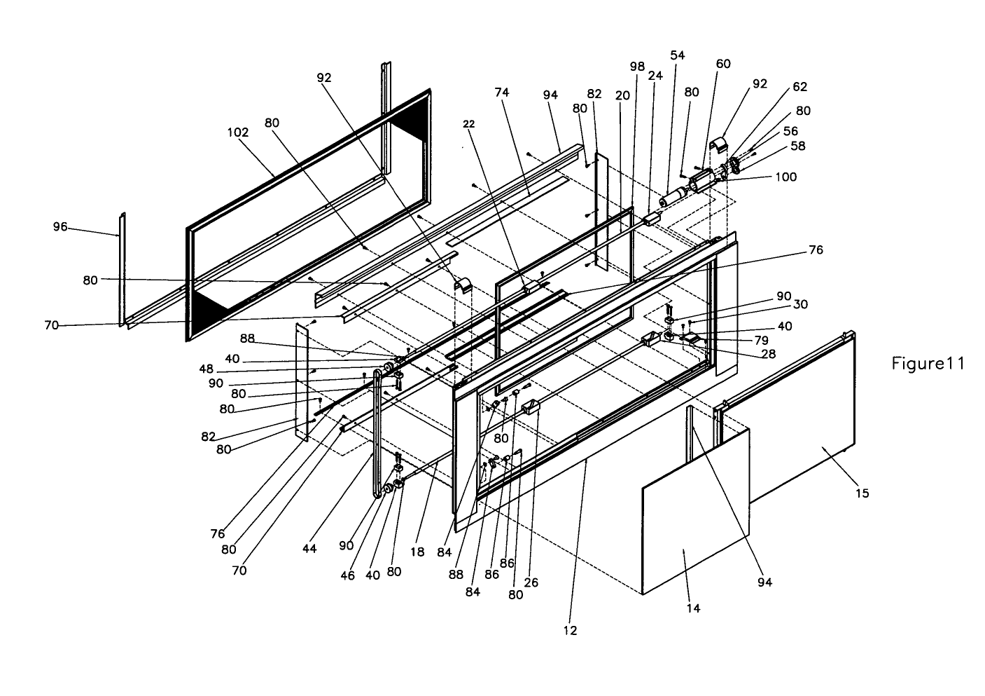

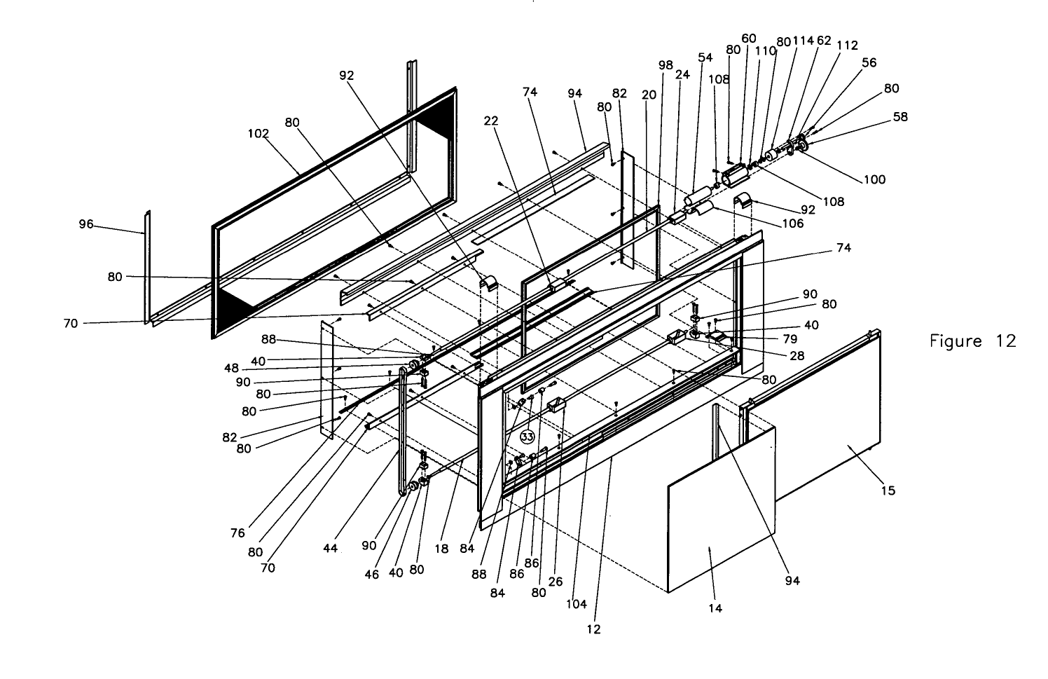

A more detailed exploded view of one embodiment of the power window 10 of the present invention is illustrated in FIG. 11. As can be seen in FIG. 11, the window 10 may also include a screen assembly 102 which extends along the length of the window 10. The screen assembly 102 is located on the interior side of the window. The incorporation of a screen that extends along the full length of the window provides a better seal to prevent the infiltration of dust and bugs into the vehicle. In addition, the view through the window is not hindered by the structure of the screen because it extends the full length of the window.

The illustrated embodiment includes additional components that have not been discussed in detail above. However, it should be noted that these additional components include items such as fasteners and jamb covers that are well known to a person skilled in the art and although they are included in the attached Figures are not meant to be limiting. The illustration merely serves to show one way of constructing the window 10 however, it is not meant to be limiting and it will be understood that other ways of constructing the window 10, including variations to the type of fasteners, covers and connections used in the window, are included within the scope of the invention. Generally the fasteners included in FIG. 11 are indicated by the numeral 80, jamb covers by numeral 82, tensioner bracket by numeral 84, tensioner roller by numeral 86, washers by numeral 88, shaft support block cover by numeral 90, and gear covers by numeral 92. In addition, the window 10 also includes header access cover 94, clamping assay 96, electrical assay 98 which is part of the motor assembly, flange bearing 100 and screen assembly 102.

In a further embodiment, illustrated in FIG. 12, the window may optionally include an antifriction strip, indicated at numeral 104. The antifriction strip 104 is attached to the bottom of the window at a position to enable the sliding members to travel therealong, as opposed to directly on the window frame. The use of the strip 104 is to reduce friction and wear between the sliding members and the frame. However, it will be understood that this component is optional.

The window may also optionally include a vibration damper pad, indicated at numeral 106 in FIG. 12. The vibration damper pad 106 is made from sound absorbing material and is operable to cover the gear motor. When in use, the vibration damper pad 106 provides a reduction in the sound level of the window.

The window may also include a flexible coupler 108, or jaw coupler, and a spider 110, that decouple the gear motor from the drive shaft which also reduces the sound level of the window. The flexible coupler 108 and spider 110 are located inside the motor mount between the gear motor 54 and an output shaft 114. It will be understood by a person skilled in the art that these components may only be used when a specific type of electric motor is used and a noise reduction is required.

The window may also include an output shaft 112, which allows for transmission of the rotational force of the motor to the gear 54, and an output shaft support 114 which supports the output shaft 112 and also maintains the correct lash between gears 56 and 58.

As stated above, the invention described herein provides a power slider window that includes bonded fixed glass panes that provide a simple design when compared to those including glass panes that are connected using screws and similar attachment means. The bonded panes contribute to improved water tightness and reduced wind noise when the window is installed and in use on a vehicle.

While this invention has been described with reference to illustrative embodiments and examples, the description is not intended to be construed in a limiting sense. Thus, various modifications of the illustrative embodiments, as well as other embodiments of the invention, will be apparent to persons skilled in the art upon reference to this description. It is therefore contemplated that the appended claims will cover any such modifications or embodiments. Further, all of the claims are hereby incorporated by reference into the description of the preferred embodiments.

What is claimed is:

1. A sliding window assembly comprising:
at least one fixed window pane;
at least one drive shaft extending in a parallel plane relative to the fixed window pane; and
at least one sliding window pane mounted on the at least one drive shaft and operable to slide therealong, the sliding window pane also being operable to be displaced in a perpendicular direction relative to the fixed window pane.

2. The sliding window assembly defined in claim 1, fuirther comprising a motor assembly connected to the at least the drive shaft for enabling movement of the sliding window pane along the at least one drive shaft.

3. The sliding window assembly defined in claim 2, further comprising a switch coupled to the motor assembly for operating the motor assembly.

4. The sliding window assembly defined in claim 1, further comprising a screen operable to cover at least one the sliding window.

5. A sliding window assembly defined in claim 1, further comprising a frame within which the at least one fixed window pane is mounted.

6. The sliding window assembly defined in claim 5, wherein the fixed pane is bonded to the mainframe.

7. The sliding window assembly defined in claim 5, wherein the sliding pane is connected to at least one sliding member mounted on and operable to move along the at least one drive shaft.

8. The sliding window assembly defined in claim 7, wherein the sliding pane comprises at least one pin extending therefrom, the at least one pin being operable to extend into a channel located in the at least one sliding member.

9. The sliding window assembly defined in claim 5, wherein the sliding pane is mounted in a sash frame.

10. The sliding window assembly defined in claim 9, wherein the sliding pane is bonded to the sash frame.

11. The sliding window assembly defined in claim 6, further comprising at least one guide means connected to the mainframe adjacent at least one of the upper and lower edges of the sliding pane for guiding the movement of the sliding pane.

12. The sliding window assembly defined in claim 11, comprising at least one guide means that defines a first pathway for guiding the sliding window in a perpendicular direction relative to the fixed window.

13. The sliding window assembly defined in claim 11, comprising a second guide means that defines a second pathway for guiding the sliding window in a parallel direction relative to the fixed window.

14. A sliding window assembly comprising
a frame;
at least one fixed window portion mounted within the frame;
an upper and a lower drive shaft each comprising a pair of sliding members mounted thereon, each of the sliding members operable to move along the corresponding drive shaft;
at least one displaceable window portion comprising a plurality of projections extending therefrom, each operable to be received within one of the sliding members to couple the window to the sliding members, the displaceable window portion being operable to move perpendicular to the drive shafts and parallel thereto.

15. The sliding window assembly defined in claim 14, further comprising at least one guide means coupled to the frame and operable to guide at least one projection in a perpendicular direction and a parallel direction relative to the drive shafts

16. The sliding window assembly defined in claim 15, comprising a plurality of guide means located between the window portions and the drive shafts.

17. The sliding window assembly defined in claim 14, wherein each sliding member further comprises a channel for receiving a corresponding projection therein.

18. The sliding window assembly defined in claim 17, wherein the channels are configured to allow each pin to move in a perpendicular direction relative to the drive shafts while the sliding member moves in a parallel direction relative to the drive shafts.

19. The sliding window assembly defined in claim 15, wherein at least one of the guide means comprises a first edge portion that guides the corresponding pin in a perpendicular direction relative to the drive shafts and a second edge portion that guides the pin in a parallel direction relative to the drive shafts.

20. The sliding window assembly defined in claim 15, wherein the at least one guide means defines a first passageway perpendicular to the axis of the drive shaft and a second passageway parallel to the drive shaft axis, the first passageway being connected to the second passageway and sized to receive at least one pin therein, wherein when the at least one pin travels along the first passageway the displaceable window moves perpendicular relative to the drive shaft and when the pin moves along the second passageway the displaceable window moves parallel to the axis of the drive shaft.

21. A power sliding window assembly comprising
a frame;
at least one fixed window portion mounted within the frame;
an upper and a lower drive shaft each comprising a pair of sliding members mounted thereon, each of the sliding members operable to move along the corresponding drive shaft;
at least one displaceable window portion positionable between a plurality of open configurations and a closed configuration and connected to each of the sliding members for sliding the displaceable window portion between the open and closed configurations, the displaceable window being operable to move perpendicular and parallel relative to the drive shafts when opening and closing; and
a motor assembly operably connected to at least one of the upper and lower drive shafts for moving the corresponding sliding members along the at least one drive shaft.
